(19) United States
(12) Patent Application Publication
(10) Pub. No.: US 2025/0024991 A1
(43) Pub. Date: Jan. 23, 2025

(54) HEATING METHOD, SYSTEM AND DEVICE FOR AIR FRYER, AND STORAGE MEDIUM

(71) Applicant: Guangzhou Qingkuai Innovation Technology Co., Ltd., Guangzhou (CN)

(72) Inventor: Huiqi HE, Guangzhou (CN)

(73) Assignee: Guangzhou Qingkuai Innovation Technology Co., Ltd., Guangzhou (CN)

(21) Appl. No.: 18/760,870

(22) Filed: Jul. 1, 2024

(30) Foreign Application Priority Data
Jul. 20, 2023 (CN) 202310896578.9

(51) Int. Cl. A47J 37/06; A47J 36/32

(52) U.S. Cl. CPC A47J 37/0641; A47J 36/32; A47J 2202/00

(57) ABSTRACT

A heating method includes: acquiring a state signal of a drawer sensing module, and judging whether a drawer of a cooking cavity is in a closed state according to the state signal; if the drawer is in the closed state, controlling a heating element to start working and recording a working time, and judging whether the working time of the heating element exceeds a first preset time; if the working time of the heating element exceeds the first preset time, controlling a fan motor to start working; and if the working time of the heating element does not exceed the first preset time, acquiring a temperature signal of a temperature sensor, judging whether a temperature in the cooking cavity exceeds a first preset temperature according to the temperature signal, and if the temperature in the cooking cavity exceeds the first preset temperature, controlling the fan motor to start working.

### CROSS-REFERENCE TO RELATED APPLICATION

This application is based on and claims the benefit of priority from Chinese Patent Application No. 202310896578.9, filed on 20 Jul. 2023, the entirety of which is incorporated by reference herein.

### TECHNICAL FIELD

The present disclosure relates to the field of cooking appliances, and more particularly, to a heating method, system and device for an air fryer, and a storage medium.

### BACKGROUND

Air fryer is a cooking appliance that utilizes high-speed hot air circulation to achieve a frying effect. It uses high-temperature heating tubes arranged inside the air fryer to heat the air, and a fan to blow the air heated by the heating tubes into a pot to cook food. However, in the existing air fryer, the operation of the fan typically causes a significant loss of heat at the beginning of the cooking process. This results in a slow temperature rise within the cooking cavity, requiring more time to reach the user-set cooking temperature.

### SUMMARY

In view of this, it is an objective of the embodiments of the present disclosure to provide a method, a system and a device for rapidly preheating an air fryer, and a storage medium, so as to reduce heat loss in a preheating stage of the air fryer and improve heating efficiency of the air fryer.

According to a first aspect, the embodiments of the present disclosure provide a heating method for an air fryer, comprising:
acquiring a state signal of a drawer sensing module, and judging whether a drawer of a cooking cavity is in a closed state according to the state signal;
if the drawer is in the closed state, controlling a heating element to start working and recording a working time, and judging whether the working time of the heating element exceeds a first preset time;
if the working time of the heating element exceeds the first preset time, controlling a fan motor to start working; and
if the working time of the heating element does not exceed the first preset time, acquiring a temperature signal of a temperature sensor, judging whether a temperature in the cooking cavity exceeds a first preset temperature according to the temperature signal, and if the temperature in the cooking cavity exceeds the first preset temperature, controlling the fan motor to start working.

Optionally, the method further comprises:
if the temperature in the cooking cavity does not exceed the first preset temperature, returning to the step of judging whether the working time of the heating element exceeds the first preset time.

Optionally, the method further comprises:
if the drawer is in a non-closed state, prohibiting the heating element from being activated.

Optionally, the method further comprises:
continuously acquiring the state signal of the drawer sensing module during working process of the heating element, and judging whether the drawer of the cooking cavity is in the closed state according to the state signal;
if the drawer is in the closed state, maintaining working states of the heating element and the fan motor unchanged; and
if the drawer is in a non-closed state, controlling the heating element to stop working, and prohibiting the fan motor from starting or controlling the fan motor to stop working.

Optionally, the method further comprises:
if the temperature in the cooking cavity does not exceed the first preset temperature, judging whether the temperature in the cooking cavity rises; and

if the temperature in the cooking cavity does not rise, reporting an error and controlling the heating element to stop working.

Optionally, the method further comprises:

acquiring a food temperature signal in the cooking cavity, and determining whether a rising speed of the food temperature in the cooking cavity is less than a preset speed according to the food temperature signal;
if the rising speed of the food temperature in the cooking cavity is less than the preset speed, controlling the heating element to work at a first preset power thereof, and controlling the fan motor to work at a first preset rotating speed thereof; and
if the rising speed of the food temperature in the cooking cavity is greater than the preset speed, controlling the heating element to work at a second preset power thereof, and controlling the fan motor to work at a second preset rotating speed thereof.

According to a second aspect, the embodiments of the present disclosure provide a heating system for an air fryer, comprising:
a first module configured for acquiring a state signal of a drawer sensing module, and judging whether a drawer of a cooking cavity is in a closed state according to the state signal;
a second module configured for, if the drawer is in the closed state, controlling a heating clement to start working and recording a working time, and judging whether the working time of the heating element exceeds a first preset time;
a third module configured for, if the working time of the heating element exceeds the first preset time, controlling a fan motor to start working; and
a fourth module configured for, if the working time of the heating element does not exceed the first preset time, acquiring a temperature signal of a temperature sensor, judging whether a temperature in the cooking cavity exceeds a first preset temperature according to the temperature signal, and if the temperature in the cooking cavity exceeds the first preset temperature, controlling the fan motor to start working.

According to a third aspect, the embodiments of the present disclosure provide a heating device for an air fryer, comprising:
at least one processor; and
at least one memory configured for storing at least one program;
wherein, the at least one program, when executed by the at least one processor, causes the at least one processor to realize the method as described above.

According to a fourth aspect, the embodiments of the present disclosure provide a computer-readable storage medium storing a processor-executable program, wherein the processor-executable program, when executed by a processor, causes the processor to realize the method as described above.

According to a fifth aspect, the embodiments of the present disclosure provide an air fryer, comprising a fan motor, a controller, a fan blade, a heating element, a temperature sensor, a drawer sensing module and a cooking cavity, wherein:
the drawer sensing module is arranged in the cooking cavity, and configured for monitoring a state signal of a drawer of the cooking cavity and sending the state signal to the controller;
the temperature sensor is arranged in the cooking cavity, and configured for measuring a temperature signal in the cooking cavity and sending the temperature signal to the controller;
the heating element is arranged in the cooking cavity, and configured for heating the cooking cavity according to a control signal sent by the controller;
the fan motor is arranged in the air fryer, and configured for being activated or inactivated according to the control signal sent by the controller to control rotation of the fan blade; and
the controller is arranged in the air fryer, and configured for controlling the fan motor and the heating element according to the temperature signal and the state signal received.

The embodiments of the present disclosure have the following beneficial effects. In the preheating stage, the heating method provided by the embodiments of the present disclosure firstly controls the heating element to start working and keeps the fan motor closed, and when the temperature in the cooking cavity reaches the first preset temperature or the working time of the heating element reaches the first preset time, the fan motor is controlled to start working. This reduces the heat loss in the cooking cavity in the preheating stage, thereby reducing the time required for preheating and improving the heating efficiency of the air fryer. Setting the first preset time of the heating element prevents a safety problem caused by the failure of the temperature sensor and improves the safety of the air fryer. The drawer sensing module is further arranged for sensing the closed state of the drawer of the cooking cavity, and when the drawer is in the non-closed state, the heating element and the fan motor are controlled not to work, further improving the safety of the air fryer during use.

### BRIEF DESCRIPTION OF THE DRAWINGS

FIG. 1 is a flow chart of steps of a heating method for an air fryer provided by the embodiments of the present disclosure;

FIG. 2 is a flow chart of steps of another heating method for an air fryer provided by the embodiments of the present disclosure;

FIG. 3 is a structural block diagram of a heating system for an air fryer provided by the embodiments of the present disclosure;

FIG. 4 is a structural block diagram of a heating device for an air fryer provided by the embodiments of the present disclosure;

FIG. 5 is a schematic structural diagram of an air fryer provided by the embodiments of the present disclosure; and

FIG. 6 is a schematic structural diagram of a food temperature sensor of an air fryer provided by the embodiments of the present disclosure.

Reference numerals: 1—fan motor; 2—controller; 3—fan blade; 4—heating element; 5—temperature sensor; 6—drawer sensing module; 7—cooking cavity; and 8—food temperature sensor.

### DETAILED DESCRIPTION

The present disclosure will be further described in detail below with reference to the accompany drawings and specific embodiments. For the step numbers in the following embodiments, they are only set for convenience of explanation, the order between the steps is not limited, and the execution order of each step in the embodiments may be adaptively adjusted according to the understanding of those of ordinary skills in the art.

In the following description, reference is made to “some embodiments”, which describe a subset of all possible embodiments, but it is understood that “some embodiments” may be the same subset or different subsets of all possible embodiments, and may be combined with each other without conflict.

In the following description, the terms “first/second/third” are only used to distinguish similar objects, and do not represent a specific ordering of the objects. It should be understood that “first/second/third” may be interchanged in a specific order or sequence if permitted, so that the embodiments of the present disclosure described here can be implemented in other orders than those illustrated or described here.

Unless otherwise defined, all the technical and scientific terms used in the embodiments of the present disclosure have the same meanings as those commonly understood by those of ordinary skills in the art of the present disclosure. The terms used in the embodiments of the present disclosure are for the purpose of describing the embodiments of the present disclosure only and are not intended to limit the present disclosure.

Before the embodiments of the present disclosure are further explained in detail, the nouns and terms involved in the embodiments of the present disclosure are explained, and the nouns and terms involved in the embodiments of the present disclosure are applicable to the following explanations.

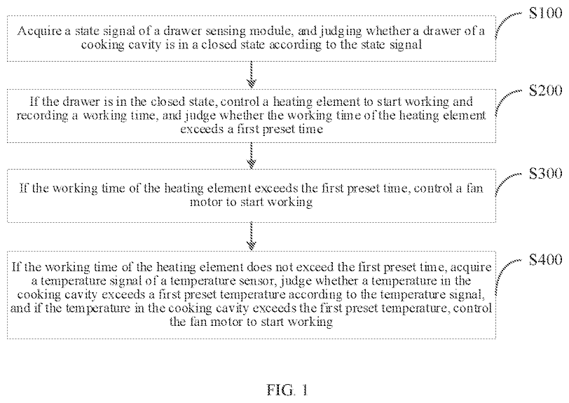

As shown in FIG. 1, the embodiments of the present disclosure provide a heating method for an air fryer, comprising the following steps.

At S100, a state signal of a drawer sensing module is acquired, and it is judged whether a drawer of a cooking cavity is in a closed state according to the state signal.

Specifically, the cooking cavity comprises one detachable drawer for placing food to be cooked by the air fryer. The drawer is provided with a drawer sensing module.

Specifically, the state signal comprises two state signals respectively corresponding to the closed state and a non-closed state of the drawer. It is judged whether the drawer is in the closed state before controlling the heating element to work, so as to improve safety protection for a user and prevent the user from being scalded.

At S200, if the drawer is in the closed state, a heating element is controlled to start working and a working time is recorded, and it is judged whether the working time of the heating element exceeds a first preset time.

Specifically, the first preset time t is determined according to actual situations, which is not limited in the embodiments of the present disclosure, and only specific embodiments are provided for reference.

Specifically, recording the working time may comprise recording the working time of the heating element at a first preset time period, and comparing the latest recorded working time with the first preset time t to judge whether the working time of the heating element exceeds the first preset time. The first preset time period is determined according to actual situations and is not limited in the embodiments of the present disclosure.

At S300, if the working time of the heating element exceeds the first preset time, a fan motor is controlled to start working.

Specifically, a priority of the first preset time t is higher than a priority of the first preset temperature T. When the working time of the heating element exceeds the first preset time, the heating element is controlled to start working regardless of whether the temperature signal of the temperature sensor indicates reaching the first preset temperature T.

At S400, if the working time of the heating element does not exceed the first preset time, a temperature signal of a temperature sensor is acquired, and it is judged whether a temperature in the cooking cavity exceeds a first preset temperature according to the temperature signal, and if the temperature in the cooking cavity exceeds the first preset temperature, the fan motor is controlled to start working.

Specifically, after the heating element starts to work, the temperature signal of the temperature sensor is continuously acquired. The first preset temperature T is determined according to actual situations, which is not limited in the embodiments of the present disclosure, and only specific embodiments are provided for reference, for example, T ranges from 60° C. to 200° C.

Specifically, the first preset temperature T is lower than a maximum temperature that the air fryer can bear. The first preset temperature T lower than the maximum temperature that the air fryer can bear is determined according to actual situations, which is not limited in the embodiments of the present disclosure, and only specific embodiments are provided for reference, for example, the first preset temperature is lower than the maximum temperature by 30° C. to 40° C. Optionally, the method further comprises:

S410: if the temperature in the cooking cavity does not exceed the first preset temperature, returning to the step of judging whether the working time of the heating element exceeds the first preset time.

Specifically, if the temperature in the cooking cavity does not exceed the first preset temperature, the working time of the heating element is continuously recorded, and it is judged whether the working time of the heating element exceeds the first preset time, and if it exceeds the first preset time, the fan motor is controlled to start working; if the working time of the heating element does not exceed the first preset time, it is continuously judged whether the temperature in the cooking cavity exceeds the first preset temperature, and if the temperature in the cooking cavity exceeds the first preset temperature, the fan motor is controlled to start working. If the temperature in the cooking cavity does not exceed the first preset temperature, it is returned to the step of judging whether the working time of the heating element exceeds the first preset time.

Optionally, the method further comprises:

S101: if the drawer is in a non-closed state, prohibiting the heating element from being activated.

Specifically, before the heating element starts working, the state signal of the drawer sensing module is acquired, and it is judged whether the drawer of the cooking cavity is in the closed state according to the state signal; if the drawer is in the non-closed state, the heating element is prohibited from being activated, so as to prevent the heating element from damaging internal devices of the air fryer or causing harm to the user.

Optionally, the method further comprises:

S210: continuously acquiring the state signal of the drawer sensing module during the working process of the heating element, and judging whether the drawer of the cooking cavity is in the closed state according to the state signal;

S211: if the drawer is in the closed state, maintaining working states of the heating element and the fan motor unchanged; and

S212: if the drawer is in a non-closed state, controlling the heating element to stop working, and prohibiting the fan motor from starting or controlling the fan motor to stop working.

Specifically, the state signal of the drawer sensing module is acquired continuously, wherein the state signal of the drawer sensing module may be acquired after a preset step, or the state signal of the drawer sensing module may be acquired once every second preset time period. The second preset time period is determined according to actual situations and is not limited in the embodiments of the present disclosure.

Optionally, the method further comprises:

S420: if the temperature in the cooking cavity does not exceed the first preset temperature, judging whether the temperature in the cooking cavity rises; and

S421: if the temperature in the cooking cavity does not rise, reporting an error and controlling the heating element to stop working.

Specifically, in the cooking process, the temperature signal of the temperature sensor is continuously acquired to judge whether the temperature signal rises, and whether the temperature in the cooking cavity rises is judged according to whether the temperature signal rises. If the temperature in the cooking cavity rises, it is judged whether the working time of the heating element exceeds the first preset time.

Specifically, if the temperature in the cooking cavity does not rise, the controller reports an error, so that the air fryer sends an error notification to the user and controls the heating element to stop working. The error notification may be made by displaying a text message or making a notification sound.

Optionally, the method further comprises:

S500: acquiring a food temperature signal in the cooking cavity, and determining whether a rising speed of the food temperature in the cooking cavity is less than a preset speed according to the food temperature signal;

S501: if the rising speed of the food temperature in the cooking cavity is less than the preset speed, controlling the heating clement to work at a first preset power thereof, and controlling the fan motor to work at a first preset rotating speed thereof; and

S502: if the rising speed of the food temperature in the cooking cavity is greater than the preset speed, controlling the heating element to work at a second preset power thereof, and controlling the fan motor to work at a second preset rotating speed thereof.

Specifically, in the cooking process, the food temperature signal is acquired through a food temperature sensor, and whether the rising speed of the food temperature in the cooking cavity is less than the preset speed is judged according to the food temperature signal.

Specifically, the first preset power is the maximum working power of the heating element, and the first preset rotating speed is the maximum preset rotating speed of the fan motor. If the rising speed of the food temperature in the cooking cavity is less than the preset speed, the heating element is controlled to work at the first preset power thereof, and the fan motor is controlled to work at the first preset rotating speed thereof, so as to achieve the purpose of rapidly heating the food.

Specifically, the second preset power is smaller than the first preset power, and the second preset rotating speed is smaller than the first preset rotating speed. The second preset power and the second preset rotating speed are determined according to actual situations, which are not limited in the embodiments of the present disclosure.

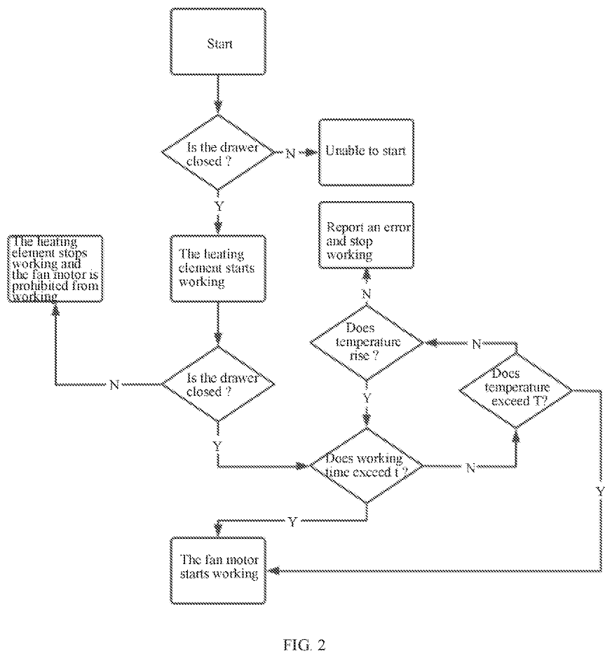

As shown in FIG. 2, the embodiments of the present disclosure further provide a flow chart of steps of a heating method for an air fryer, wherein the heating method comprises:
after a controller receives a signal to start working, judging whether a drawer of a cooking cavity is in a closed state;
if the drawer is in the closed state, controlling a heating element to start working and recording a working time;
if the drawer is in a non-closed state, prohibiting the heating element from being activated;
after the heating element starts working, judging whether the drawer of the cooking cavity is in the closed state again;
if the drawer is in the closed state, judging whether the working time of the heating element exceeds a first preset time;
if the drawer is in a non-closed state, controlling the heating element to stop working, and prohibiting the fan motor from starting;
if the working time of the heating element exceeds the first preset time, controlling a fan motor to start working;
if the working time of the heating element does not exceed the first preset time, acquiring a temperature signal of a temperature sensor, and judging whether a temperature in the cooking cavity exceeds a first preset temperature according to the temperature signal;
if the temperature in the cooking cavity exceeds the first preset temperature, controlling the fan motor to start working;
if the temperature in the cooking cavity does not exceed the first preset temperature, judging whether the temperature in the cooking cavity rises;
if the temperature in the cooking cavity rises, returning to the step of judging whether the working time of the heating element exceeds the first preset time; and
if the temperature in the cooking cavity does not rise, reporting an error and controlling the heating element to stop working.

The embodiments of the present disclosure have the following beneficial effects. In the preheating stage, the heating method provided by the embodiments of the present disclosure firstly controls the heating element to start working and keeps the fan motor closed, and when the temperature in the cooking cavity reaches the first preset temperature or the working time of the heating element reaches the first preset time, the fan motor is controlled to start working. This reduces the heat loss in the cooking cavity in the preheating stage, thereby reducing the time required for preheating and improving the heating efficiency of the air fryer. Setting the first preset time of the heating element prevents a safety problem caused by the failure of the temperature sensor and improves the safety of the air fryer. The drawer sensing module is further arranged for sensing the closed state of the drawer of the cooking cavity, and when the drawer is in the non- closed state, the heating element and the fan motor are controlled not to work, further improving the safety of the air fryer during use.

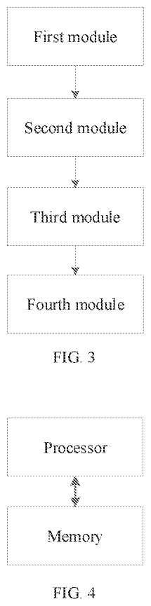

As shown in FIG. 3, an embodiment of the present disclosure provides a heating system for an air fryer, comprising:
a first module configured for acquiring a state signal of a drawer sensing module, and judging whether a drawer of a cooking cavity is in a closed state according to the state signal;
a second module configured for, if the drawer is in the closed state, controlling a heating clement to start working and recording a working time, and judging whether the working time of the heating element exceeds a first preset time;
a third module configured for, if the working time of the heating element exceeds the first preset time, controlling a fan motor to start working; and
a fourth module configured for, if the working time of the heating element does not exceed the first preset time, acquiring a temperature signal of a temperature sensor, judging whether a temperature in the cooking cavity exceeds a first preset temperature according to the temperature signal, and if the temperature in the cooking cavity exceeds the first preset temperature, controlling the fan motor to start working.

It can be seen that the contents in the above method embodiments are all applicable to this system embodiment, the functions specifically realized by this system embodiment are the same as those of the above method embodiments, and the beneficial effects achieved are also the same as those achieved by the above method embodiments.

As shown in FIG. 4, an embodiment of the present disclosure provides a heating device for an air fryer, comprising:
at least one processor; and
at least one memory configured for storing at least one program;
wherein, the at least one program, when executed by the at least one processor, causes the at least one processor to realize the method as described above.

As a non-transient computer-readable storage medium, the memory may be used to store non-transient software programs and non-transient computer-executable programs. The memory may comprise a high-speed random access memory, and may also comprise a non-volatile memory, such as at least one disk memory device, a flash memory device, or other non-volatile solid storage devices. In some embodiments, the memory may optionally comprise memories remotely located with respect to the processor, and these remote memories may be connected to the processor via networks. Examples of the networks above comprise, but are not limited to, the Internet, intranet, local area networks, mobile communication networks, and combinations thereof.

It can be seen that the contents in the above method embodiments are all applicable to this device embodiment, the functions specifically realized by this device embodiment are the same as those of the above method embodiments, and the beneficial effects achieved are also the same as those achieved by the above method embodiments.

An embodiment of the present disclosure further provides a computer-readable storage medium storing a processor-executable program, wherein the processor-executable program, when executed by a processor, causes the processor to realize the method as described above.

It can be understood that all or some of the steps in the methods and systems disclosed above may be implemented as software, firmware, hardware, and suitable combinations thereof. Some physical components or all of the physical components may be implemented as software executed by a processor, such as a central processing unit, a digital signal processor or a microprocessor, or implemented as hardware, or implemented as an integrated circuit, such as an application specific integrated circuit. Such software may be distributed on a computer-readable medium, and the computer-readable medium may comprise a computer storage medium (or non-transitory medium) and a communication medium (or transitory medium). As is well known to those of ordinary skills in the art, the term ‘computer storage medium’ comprises volatile and non-volatile, removable and non-removable media implemented in any method or technology for storing information (such as computer-readable instruction, data structure, programming module or other data). The computer storage medium comprises, but is not limited to, RAM, ROM, EEPROM, flash memory or other memory technology, CD-ROM, digital versatile disc (DVD) or other optical disc memory, magnetic cassette, magnetic tape, magnetic disk memory or other magnetic memory device, or may be any other medium that can be used to store the desired information and can be accessed by a computer. Moreover, it is well known to those of ordinary skills in the art that the communication medium typically contains computer-readable instructions, data structures, program modules, or other data in a modulated data signal, such as a carrier wave or other transmission mechanism, and may comprise any information delivery medium.

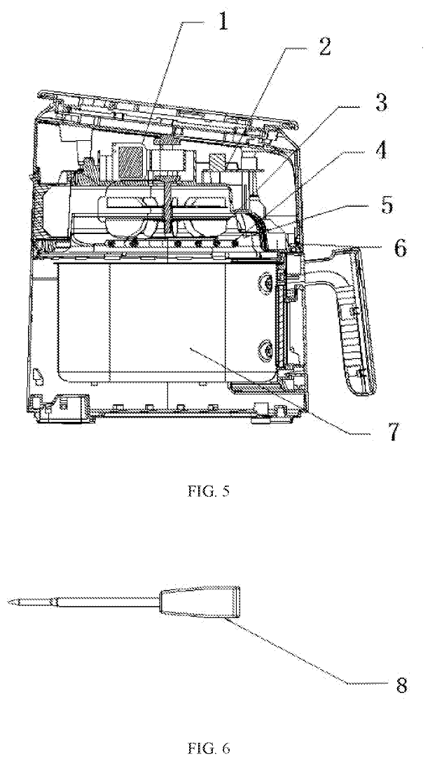

As shown in FIG. 5, an embodiment of the present disclosure provides an air fryer, comprising a fan motor 1, a controller 2, a fan blade 3, a heating clement 4, a temperature sensor 5, a drawer sensing module 6 and a cooking cavity 7, wherein:
the drawer sensing module 6 is arranged in the cooking cavity 7, and configured for monitoring a state signal of a drawer of the cooking cavity 7 and sending the state signal to the controller 2;
the temperature sensor 5 is arranged in the cooking cavity 7, and configured for measuring a temperature signal in the cooking cavity 7 and sending the temperature signal to the controller 2;
the heating element 4 is arranged in the cooking cavity 7, and configured for heating the cooking cavity 7 according to a control signal sent by the controller 2;
the fan motor 1 is arranged in the air fryer, and configured for being activated or inactivated according to the control signal sent by the controller 2 to control rotation of the fan blade 3; and
the controller 2 is arranged in the air fryer, and configured for controlling the fan motor 1 and the heating element 4 according to the temperature signal and the state signal received.

Specifically, as shown in FIG. 6, the air fryer further comprises a food temperature sensor 8 configured for measuring a food temperature in the cooking cavity. A probe of the food temperature sensor 8 is partially inserted into the food, and the food temperature sensor 8 is wirelessly connected with the controller 2.

It can be seen that the contents in the above method embodiments are all applicable to this embodiment, the functions specifically realized by this embodiment are the same as those of the above method embodiments, and the beneficial effects achieved are also the same as those achieved by the above method embodiments.

The foregoing describes the preferred embodiments of the present disclosure in detail, but the present disclosure is not limited to the embodiments, those of ordinary skills in the art can make various equal deformations or replacements without departing from the gist of the present disclosure, and these equal deformations or replacements shall all fall within the scope limited by the claims of the present disclosure.

What is claimed is:

1. A heating method for an air fryer, comprising:
acquiring a state signal of a drawer sensing module, and judging whether a drawer of a cooking cavity is in a closed state according to the state signal;
if the drawer is in the closed state, controlling a heating element to start working and recording a working time, and judging whether the working time of the heating element exceeds a first preset time;
if the working time of the heating element exceeds the first preset time, controlling a fan motor to start working; and
if the working time of the heating element does not exceed the first preset time, acquiring a temperature signal of a temperature sensor, judging whether a temperature in the cooking cavity exceeds a first preset temperature according to the temperature signal, and if the temperature in the cooking cavity exceeds the first preset temperature, controlling the fan motor to start working.

2. The heating method for an air fryer according to claim 1, further comprising:
if the temperature in the cooking cavity does not exceed the first preset temperature, returning to the step of judging whether the working time of the heating element exceeds the first preset time.

3. The heating method for an air fryer according to claim 1, further comprising:
if the drawer is in a non-closed state, prohibiting the heating element from being activated.

4. The heating method for an air fryer according to claim 1, further comprising:
continuously acquiring the state signal of the drawer sensing module during working process of the heating element, and judging whether the drawer of the cooking cavity is in the closed state according to the state signal;
if the drawer is in the closed state, maintaining working states of the heating element and the fan motor unchanged; and
if the drawer is in a non-closed state, controlling the heating element to stop working, and prohibiting the fan motor from starting or controlling the fan motor to stop working.

5. The heating method for an air fryer according to claim 1, further comprising:
if the temperature in the cooking cavity does not exceed the first preset temperature, judging whether the temperature in the cooking cavity rises; and
if the temperature in the cooking cavity does not rise, reporting an error and controlling the heating element to stop working.

6. The heating method for an air fryer according to claim 1, further comprising:
acquiring a food temperature signal in the cooking cavity, and determining whether a rising speed of the food temperature in the cooking cavity is less than a preset speed according to the food temperature signal;
if the rising speed of the food temperature in the cooking cavity is less than the preset speed, controlling the heating element to work at a first preset power of the heating element, and controlling the fan motor to work at a first preset rotating speed of the fan motor; and
if the rising speed of the food temperature in the cooking cavity is greater than the preset speed, controlling the heating element to work at a second preset power of the heating element, and controlling the fan motor to work at a second preset rotating speed of the fan motor.

7. A heating system for an air fryer, comprising:
a first module configured for acquiring a state signal of a drawer sensing module, and judging whether a drawer of a cooking cavity is in a closed state according to the state signal;
a second module configured for, if the drawer is in the closed state, controlling a heating element to start working and recording a working time, and judging whether the working time of the heating element exceeds a first preset time;
a third module configured for, if the working time of the heating element exceeds the first preset time, controlling a fan motor to start working; and
a fourth module configured for, if the working time of the heating element does not exceed the first preset time, acquiring a temperature signal of a temperature sensor, judging whether a temperature in the cooking cavity exceeds a first preset temperature according to the temperature signal, and if the temperature in the cooking cavity exceeds the first preset temperature, controlling the fan motor to start working.

8. A heating device for an air fryer, comprising:
at least one processor; and
at least one memory configured for storing at least one program;
wherein, the at least one program, when executed by the at least one processor, causes the at least one processor to realize the method according to claim 1.

9. A non-transitory computer-readable storage medium storing a processor-executable program, wherein the processor-executable program, when executed by a processor, causes the processor to realize the method according to claim 1.

10. An air fryer, comprising a fan motor, a controller, a fan blade, a heating element, a temperature sensor, a drawer sensing module and a cooking cavity, wherein:
the drawer sensing module is arranged in the cooking cavity, and configured for monitoring a state signal of a drawer of the cooking cavity and sending the state signal to the controller;
the temperature sensor is arranged in the cooking cavity, and configured for measuring a temperature signal in the cooking cavity and sending the temperature signal to the controller;
the heating element is arranged in the cooking cavity, and configured for heating the cooking cavity according to a control signal sent by the controller;
the fan motor is arranged in the air fryer, and configured for being activated or inactivated according to the control signal sent by the controller to control rotation of the fan blade; and
the controller is arranged in the air fryer, and configured for controlling the fan motor and the heating element according to the temperature signal and the state signal received respectively.
